(19) United States
(12) Patent Application Publication
(10) Pub. No.: US 2003/0073537 A1
(43) Pub. Date: Apr. 17, 2003

(54) Precision differential planetary gear drive

(75) Inventor: Carl A. Lloyd, Bloomfield, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/977,741

(22) Filed: Oct. 15, 2001

(51) Int. Cl. F16H 57/08

(52) U.S. Cl. 475/331

(57) ABSTRACT

A differential planetary gear system comprises a sun gear having a plurality of teeth; a first gear having first and second planetary gears each having a plurality of teeth and rigidly affixed to each other; a second gear having first and second planetary gears each having a plurality of teeth and pre-loaded with a pre-load mechanism against each other for eliminating backlash; a stationary gear having a plurality of teeth that matingly meshes with the teeth of each of the first planetary gears; and a movable gear having a plurality of teeth that matingly mesh with the teeth of each of the second planetary gears.

### FIELD OF THE INVENTION

The present invention relates to planetary gears having a sun gear and a plurality of two-tiered planet gears each interlocked with the sun gear and, more particularly, to such planetary gears in which one tier of one of the planet gears is coupled with its corresponding mated tier for preventing backlash of the gears.

### BACKGROUND OF THE INVENTION

Referring to FIG. 1, a planetary gear system 10 of the prior art is shown in which the sun gear 20 is rotated by the input to the system (not shown), such as a motor having its shaft 25 passing through and affixed to the sun gear 20. Three planet gears 40 surround and are interlocked with the sun gear 20. In this configuration, an internal or ring gear 30 is positioned stationary so that it does not rotate. When the motor is activated, the three planet gears 40 revolve about the central axis of the shaft 25 at a speed depending on the diameters of the gears 20 and 40 and the input speed. A planet carrier 50 links the planet gears 40 together and is connected to the driven load (not shown).

The above-described system has a ratio defined by the input speed of the sun gear 20 and the output speed of the planet carrier 50. This ratio is limited by the smallest practical diameter of the sun gear 20 and the maximum diameter of the internal gear 30 that will fit in the assembly being designed. For most compact designs, this limit is less than 10:1.

Because the gears 20 and 40 must mesh smoothly and efficiently, clearances must be allowed so that tooth binding and wear is not excessive as the gears 20 and 40 operate. These clearances give rise to inherent free play and backlash which is undesirable in a precise positioning system, such as a pointing mechanism for an antenna drive, or a precise robot manipulator.

Referring now to FIG. 2, another prior art design is depicted. The planetary gear 10 is shown in which each of the planet gears 40 consist of two gears; a first gear 40a and a second gear 40b located on the same axis and affixed to each other so that they must rotate at the same speed. The first gear 40a meshes with a stationary internal ring 30 gear similar to the design of FIG. 1, and the second planet gear 40b meshes with a second internal ring gear 60 which is free to rotate. If the two planet gears 40a and 40b are made with the same number of teeth and have the same diameter, then the second internal ring gear 60 will not rotate when the sun gear is turned. This is because the ratio of rotation of the sun gear 25 to the second internal gear 60 will be identical to the ratio of the sun gear 25 to the fixed internal gear 30 (a ratio of infinite turns of the sun gear per turn of the internal ring gear).

If however, the first 40a and second 40b planet gears have a difference of number of teeth, then the second internal ring gear 60, which must now have a different diameter than the fixed internal ring gear, will rotate at some ratio to the input sun gear 25 determined by the diameter difference between the planet gears 40a and 40b. This ratio is maximized when the diameter difference between the two planet gears 40a and 40b is a minimum. As mentioned above, as the difference in diameter between the two planet gears 40a and 40b approaches zero, the ratio of the input to the output approaches infinity. It is to be noted that the planet gears 40a and 40b do not have to have the same pitch system since they mesh with different internal ring gears.

However, one limitation on the range of possible ratios has been, that for a system with an integral number of planet gears spaced at equal angular intervals, the number of teeth on the sun, planet and internal ring gears must be exactly divisible by that number. This limitation may be overcome by unique design approaches, which may require unequal angular intervals, or the ability to vary the angular interval, but in general a symmetrical assembly is desirable for ease of manufacturing and assembly, as well as dynamic balance.

Thus, the prior art has provided a compact planetary gear system which offers very high ratios compared to single stage planetary drives and harmonic drives. However, these designs have backlash, and thus, are not suitable for high-precision drives in which backlash is unacceptable.

Consequently, there is a need for a differential planetary gear system which is backlash-free.

### SUMMARY OF THE INVENTION

The present invention is directed to overcoming one or more of the problems set forth above. Briefly summarized, according to one aspect of the present invention, the invention resides in a differential planetary gear system comprising (a) a sun gear having a plurality of teeth; (b) a first gear having first and second planetary gears each having a plurality of teeth and rigidly affixed to each other; (c) a second gear having first and second planetary gears each having a plurality of teeth and pre-loaded with a pre-load mechanism against each other for eliminating backlash; (d) a stationary gear having a plurality of teeth that matingly meshes with the teeth of each of the first planetary gears; and (e) a movable gear having a plurality of teeth that matingly mesh with the teeth of each of the second planetary gears.

These and other aspects, objects, features and advantages of the present invention will be more clearly understood and appreciated from a review of the following detailed description of the preferred embodiments and appended claims, and by reference to the accompanying drawings.

Advantageous Effect of the Invention

It is an object of the present invention to effectively eliminate free play and backlash in a differential planetary gear drive.

It is an advantage of the present invention to provide a gear drive that can constructed in a volume only slightly larger than a single planetary system, and offers gear ratios in excess of 500:1 depending on the diameter of the system and tooth pitch systems.

The present invention includes the feature of an internal pre-load that substantially eliminates free play and backlash.

### BRIEF DESCRIPTION OF THE DRAWINGS

FIG. 1 is a perspective view of a prior art planetary gear;

FIG. 2 is a perspective view of another prior art planetary gear;

FIG. 3 is a perspective view of the planetary gear of the present invention;

FIG. 4 is an alternative embodiment of the pre-loading mechanism of FIG. 3;

FIG. 5 is an alternative embodiment of the pre-loading mechanism of FIG. 3; and

FIG. 6 is an alternative embodiment of the pre-loading mechanism of FIG. 3.

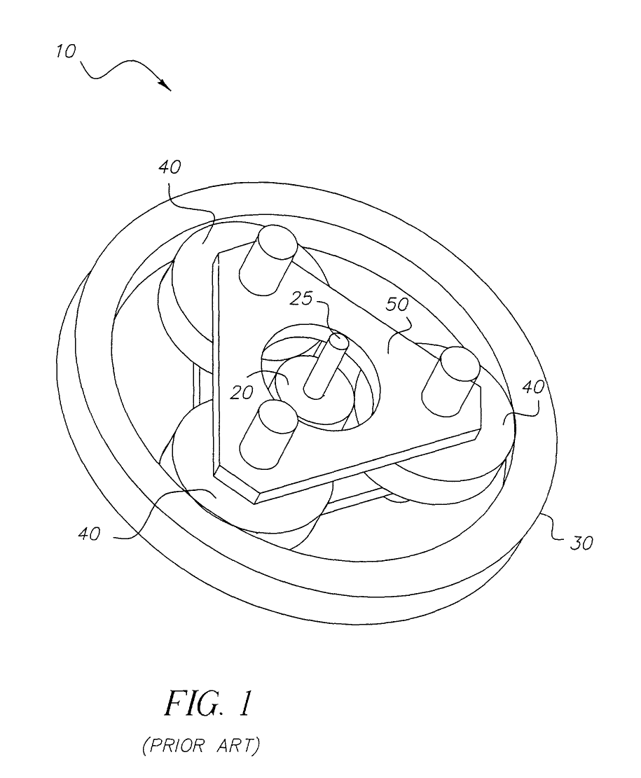

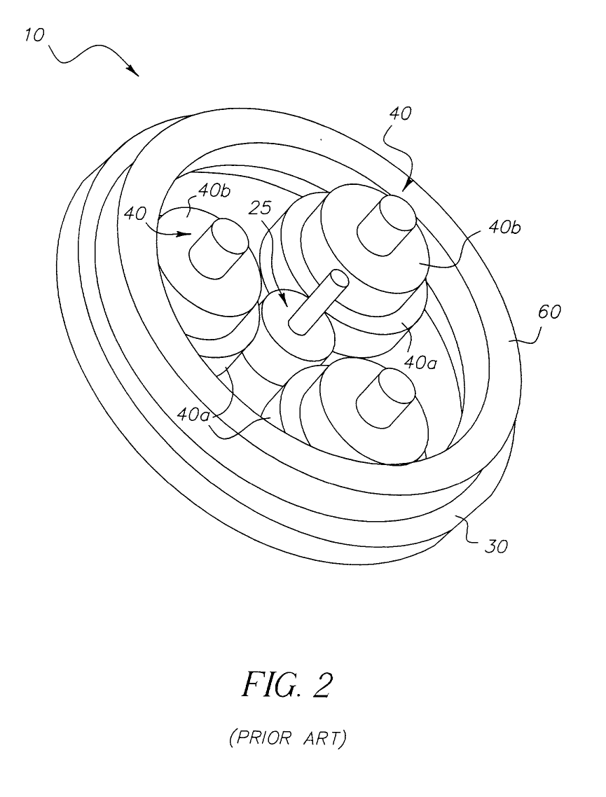

It should be noted that the bearings and housings necessary to support the various shafts and gears in these drives have not been shown, in order to simplify the drawings. However, it is recognized that these are required elements of practical devices.

### DETAILED DESCRIPTION OF THE INVENTION

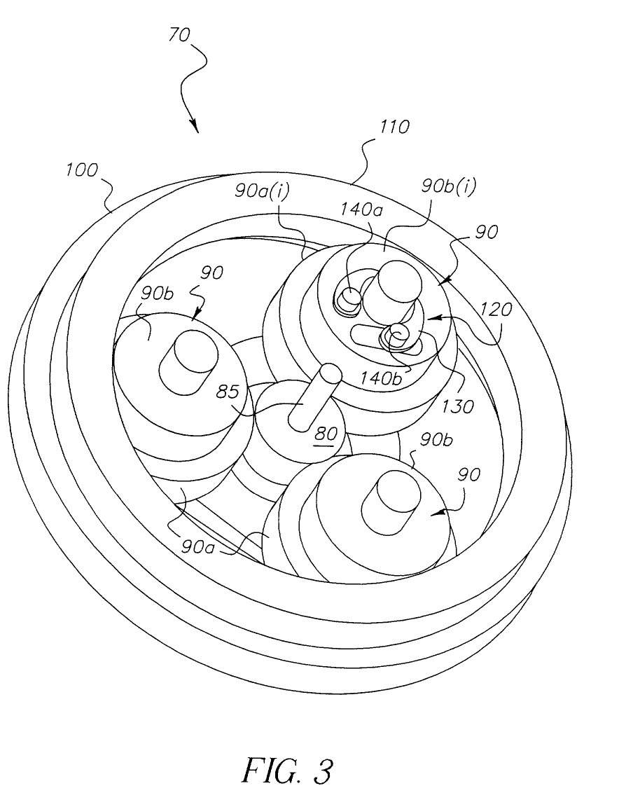

Referring now to FIG. 3, there is shown the planetary gear system of the present invention. The planetary gear 70 includes a sun gear 80 that is rotated by the input to the system (not shown), such as a motor having its shaft 85 passing through and affixed to the sun gear 80. Three planet gears 90 surround and are interlocked with the sun gear 80. An internal or ring gear 100 is held stationary so that it does not rotate.

The planetary gear 90 includes two gears; a first gear 90a and a second gear 90b located on the same axis and affixed to each other so that they must rotate at the same speed. The first gear 90a meshes with a stationary internal ring 100 gear, and the second planet gear 90b meshes with a second internal ring gear 110 which is free to rotate.

One set of the planet gears is unique in that the two gears 90a(i) and 90b(i) are not affixed to each other, but they are instead coupled to each other by a relatively soft torsional spring 120 that is used to pre-load one planet gear 90a(i) and 90b(i) against the other. The pre-load spring 120 includes a clip 130 that is loaded at the ends against two pins 140. One pin 140a is pressed into the lower planet gear 90b and protrudes through a slot (not shown) in the upper planet gear 90b. The other pin 140b is pressed into a hole (not shown) in the upper planet gear 90a. The spring clip 120 is assembled in a stressed state so that the pins 140 are forced towards each other or away from each other, thus creating a torsional pre-load about the gear shaft which is maintained by the tooth engagement between the planet gears 90 and the internal gears 110 and 110. The internal gears 100 and 110 cannot rotate to relieve this pre-load because the other two sets of planet gears 90 are rigidly joined to one another.

In this way, the entire gear system 70 is pre-loaded and backlash is removed from the system. Since the two planet gears 90a(i) and 90b(i) still rotate at the same velocity, there is no windup or change in the torsional spring torque as the system operates.

This feature makes the differential planetary gear 70 suitable for many high-precision applications for which it would normally not be chosen. In addition to optical focus and alignment mechanisms, this system would have significant advantages in many positioning systems such as robotic arm drives, precision positioning tables, antenna pointing mechanisms, machine tool drives, tool changers, photographic film drives, tape drives, etc., in which power transmission is not as important as precision and high ratio. The compactness of this system compared to other high-ratio gear drives makes possible significant weight and volume savings over harmonic drives and cascaded planetary systems.

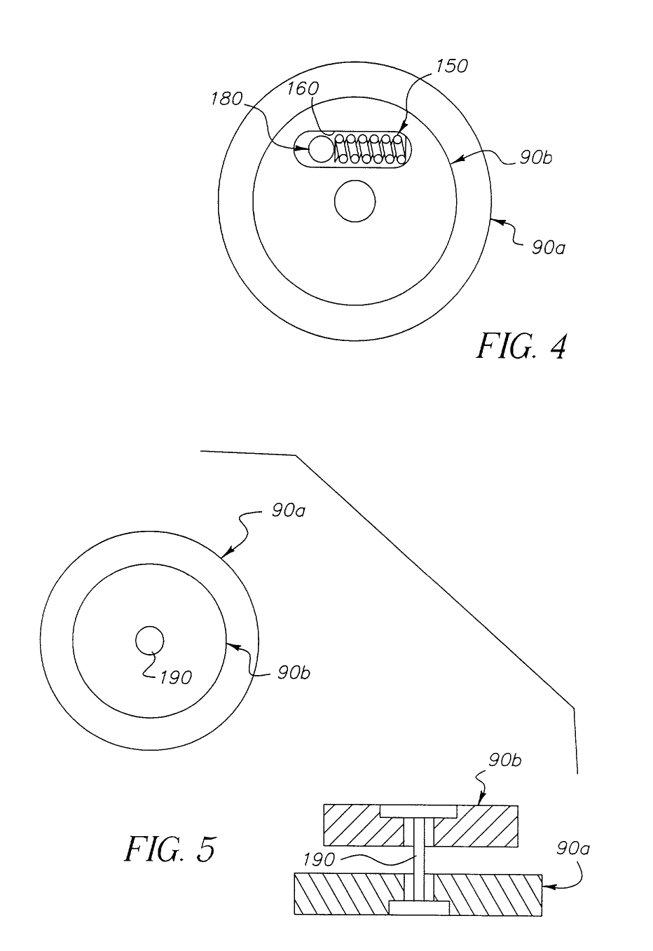

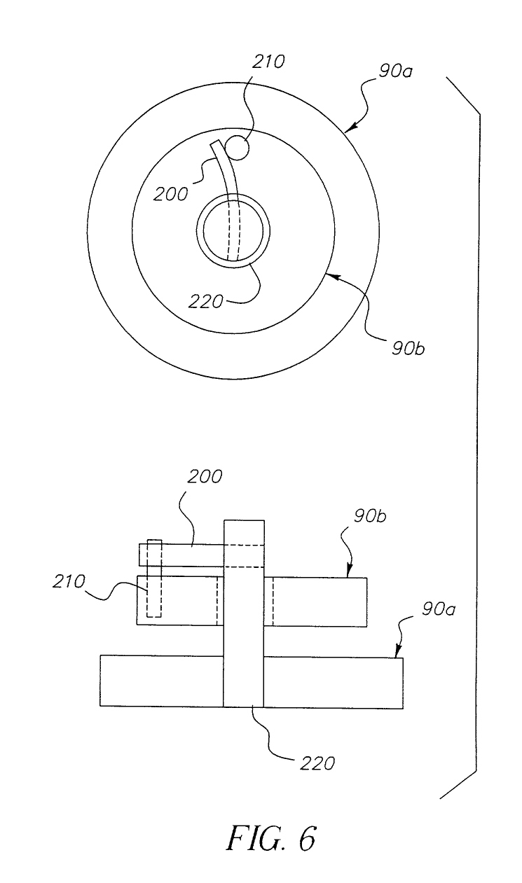

The above-described method of providing the torsional pre-load is but one of many ways in which it could be accomplished. Other methods include, but are not limited to, the following. First, and referring briefly to FIG. 4, a compression spring 150 could be inserted in the slot 160 so that a force is produced between the end of the slot 160 and the pin 180 that is pressed into the lower planet gear 90a. Secondly, and referring to FIG. 5, the shaft 190 for this set of gears 90 can be designed to be torsionally flexible and the two gears 90 could be rigidly attached to this shaft 190. Upon assembly, the shaft 190 could be twisted to create a torsional preload when the gear teeth are engaged. Finally, and referring to FIG. 6, the spring clip shown may be replaced with any of a wide variety of flexible elements such as flexure beams 200, etc, which function in the same manner. More specifically, a pin 210 is attached to the gear 90b that is mated to the shaft by the flexure beam 200. The flexure beam 200 is also rigidly attached to the shaft 220 that is, in turn, attached to the gear 90a.

The magnitude of the torsional pre-load established in the assembly should be such that the torque required for driving the load does not exceed the pre-load value. In this manner, the gear tooth contact will always be on one side of the tooth and the clearances required for smooth operation will not create backlash.

A further feature of this invention is that for precision drives in which load-carrying capacity is a secondary consideration, two of the rigid planet gear assemblies may replaced by preloaded assemblies as described above. In this case, the limitations on the number of teeth of each gear in the system are removed, since only one assembly must be assembled in simultaneous meshing with the two internal gears. The two preloaded assemblies many be “wound up” as required to meet the meshing condition. By using a low torsional spring rate, the preload on the two assemblies may be kept very close to the same value to balance wear on the entire assembly. Eliminating the constraints on the permissible combinations of tooth numbers makes possible a much greater range of gear ratios which are available from the differential planetary system. If the upper and lower planet gears are made using the same pitch system, they can differ in tooth number by only one tooth, which maximizes the ratio possible. In addition, if the upper and lower planet gears are made using different pitch systems, they can have even closer pitch diameters and even higher ratios.

This design is further applicable to systems that comprise of at least two planet gear assemblies, but may exceed three.

The invention has been described in detail with particular reference to certain preferred embodiments thereof, but it will be understood that variations and modifications can be effected within the spirit and scope of the invention.

### Parts List

| | |
|---|---|
| 10 | planetary gear system |
| 20 | sun gear |
| 25 | shaft |
| 30 | internal ring |
| 40 | planet gear |
| 50 | planet carrier |
| 60 | internal ring |
| 70 | planetary gear system |
| 80 | sun gear |
| 85 | shaft |
| 90 | planetary gear |
| 100 | internal ring |
| 110 | internal ring |
| 120 | pre-load spring |
| 130 | clip |
| 140 | pin |
| 150 | compression spring |
| 160 | slot |
| 180 | pin |
| 190 | shaft |
| 200 | flexure beam |

What is claimed is:

1. A differential planetary gear system comprising:
(a) a sun gear having a plurality of teeth;
(b) a first gear having first and second planetary gears each having a plurality of teeth and rigidly affixed to each other;
(c) a second gear having first and second planetary gears each having a plurality of teeth and pre-loaded with a pre-load mechanism against each other for eliminating backlash;
(d) a stationary gear having a plurality of teeth that matingly meshes with the teeth of each of the first planetary gears; and
(e) a movable gear having a plurality of teeth that matingly mesh with the teeth of each of the second planetary gears.

2. The gear as in claim 1 further comprising a third gear having first and second planetary gears each having a plurality of teeth, and the teeth of the stationary gear matingly meshes with the teeth of the first planetary gear and the teeth of the movable gear matingly meshed with the teeth of the second planetary gear.

3. The gear as in claim 1, wherein the pre-load mechanism includes two pins respectively interlocked with the first and second planetary gears of the second gear and a clip spring positioned between the two pins.

4. The gear as in claim 1, wherein the pre-load mechanism includes a pin rigidly attached to the first gear and a compression spring which mates another portion of the pin to the second gear.

5. The gear as in claim 1, wherein the pre-load mechanism includes a shaft affixed to each the first and second gears having a predetermined torque.

6. The gear as in claim 1, wherein the pre-load mechanism includes a shaft attached to the first gear, and a pin which is pressed into the first gear for attaching it to the second gear and which is flexibly attached to the shaft by the pin.
